(19) United States
(12) Patent Application Publication
(10) Pub. No.: US 2008/0036970 A1
(43) Pub. Date: Feb. 14, 2008

(54) LIQUID CRYSTAL PROJECTION SYSTEM WITH IMPROVED IMAGE PERFORMANCE

(75) Inventors: Chien-Chih Hsiung, Taichung (TW); Keng-Hui Lin, Taichung (TW); Tsi-Lung Wu, Taichung (TW); Wen-Lang Hung, Taichung (TW)

Correspondence Address: MADSON & AUSTIN, 15 WEST SOUTH TEMPLE, SUITE 900, SALT LAKE CITY, UT, 84101, US

(73) Assignee: Asia Optical Co., Inc, Taichung (TW)

(21) Appl. No.: 11/689,908

(22) Filed: Mar. 22, 2007

(30) Foreign Application Priority Data
Aug. 9, 2006 (TW) 095129213

(51) Int. Cl. G03B 21/14

(52) U.S. Cl. 353/20

(57) ABSTRACT

A liquid crystal projection system (70) includes a light source (50) for emitting a white light beam of three primary colors, a polarizer (51) for polarizing the white light beam, a separating mirror (52), first and second reflecting mirrors (53, 54), first and second polarization separators (56, 57), a half-wave plate (55), a color separator (58), an image modulation device (60R, 60G, 60B) and a projection lens (59). The first polarization separator, the second polarization separator and the color separator are combined together as a unit. The half-wave plate is positioned between the first and second polarization separators. The image modulation device is arranged on sides of the first polarization separator and the color separator. The projection lens is disposed on one side of the second polarization separator. Both monochromatic and bichromatic light beams from the separating mirror are respectively incident into the first and second polarization separators in an S-polarization state.

### BACKGROUND OF THE INVENTION

1. Field of the Invention

The present invention relates to a liquid crystal projection system and in particular to a liquid crystal projection system with improved image performance, which utilizes three reflection type liquid crystal panels for image projection output.

2. Description of Prior Art

A liquid crystal projector can be classified into a single-panel type and a three-panel type by the number of liquid crystal panels to be used. A single-panel projector is low in resolution and brightness, but is economic in cost. A three-panel projector has the advantages of high resolution and high brightness, but is expensive in cost. The working principle for a three-panel projector is to separate a white light from a light source into three primary color lights of red (R), green (G) and blue (B), then guide the three primary color lights to enter into respective red-color, green-color and blue-color liquid crystal display panels, recombine the three primary color lights reflected from the respective liquid crystal display panels, and finally project them onto a screen via a projection lens.

A conventional three-panel liquid crystal projector generally includes, in order from a light source to a screen, an integrator, a PBS (Polarization Beam Splitter) array, condense lenses, dichroic mirrors, reflecting mirrors, an X-cube and a projection lens. The integrator is adapted to provide a uniform, high intensity light beam and transform the circular cross section of the incident light beam from the light source into a rectangular one corresponding to the shape of a liquid crystal panel. The PBS array is provided for polarization transformation so as to increase the utility efficiency of light energy. The condenser lens maintains the light beam in a converged state to ensure a uniform light energy distribution. The dichroic mirror, which has optical films coated thereon, splits the white light from the light source into three primary color lights of red (R), green (G) and blue (B). The reflecting mirror reflects the incident light for changing the light path. The X-cube recombines the three primary color lights of red (R), green (G) and blue (B) after their transformation and modulation by respective liquid crystal panels. Finally, the projection lens projects an enlarged image onto the screen.

FIG. 1 illustrates the configuration of a conventional three-panel liquid crystal projection system that is disclosed in U.S. Pat. No. 6,819,497. Such a conventional liquid crystal projection system includes a light source 36, four PBSs 31, 32, 33, 34 and reflective liquid crystal panels 39R, 39G, 39B. Specifically, the PBSs 32, 33, 34 are cemented together as a unit. A color selective polarizer 37 is disposed between the light source 36 and the PBS 31, a glass plate 35 is disposed between the PBSs 32, 34, and a color selective polarizer 38 is further disposed between the PBSs 33, 34.

In the above conventional projection system, the three primary color lights Rs, Gs, Bs emitted from the light source 36 are converted into Rs, Gp, Bs after passing through the color selective polarizer 37 and then incident into the first PBS 31. Two primary color lights Rs, Bs are reflected by the first PBS 31, converted into Rp, Bs by a color selective polarizer 30, and then incident into the third PBS 33. The primary color light Gp is transmitted through the first PBS 31 and then incident into the second PBS 32. The color light Rp is transmitted through the third PBS 33, incident into the reflective liquid crystal panel 39R, and returns to the third PBS 33 as an S-polarization light Rs after transformation and modulation by the reflective liquid crystal panel 39R. The color light Rs is then reflected by the third PBS 33, converted into a P-polarization light Rp by the color selective polarizer 38, and then incident into the fourth PBS 34. The color light Bs is reflected into the reflective liquid crystal panel 39B by the third PBS 33, and then returns to the third PBS 33 as a P-polarization light Bp after transformation and modulation by the reflective liquid crystal panel 39B. The color light Bp is then transmitted through the third PBS 33 and incident into the fourth PBS 34. The color light Gp is transmitted through the second PBS 32, is incident into the reflective liquid crystal panel 39G, then returns to the second PBS 32 as an S-polarization light Gs after transformation and modulation by the reflective liquid crystal panel 39Q and is finally incident into the fourth PBS 34 by reflection of the second PBS 32. Therefore, the primary color lights that are incident into the second, third and fourth PBSs 32, 33, 34 are Gp; Rp, Bs; and Rp, Bp, Gs, respectively. However, it is known that the utility efficiency of the S-polarization light in a PBS is 99 percent, while the P-polarization light is only 90 percent. The remaining unutilized 10 percent will cause the color phase shift problem due to light interference. Therefore, in the above conventional projection system, since the majority of primary color lights enter the second, third and fourth PBSs 32, 33, 34 in a P-polarization state rather than an S-polarization state, the utility efficiency of the primary color lights in this system is decreased and thus the color phase shift problem may occur.

In addition, the above conventional liquid crystal projection system has four PBSs 31, 32, 33, 34, and additionally includes the two color selective polarizers 37, 38 and the glass plate 35. This increases the number of system components, the system volume and costs.

Accordingly, an improved liquid crystal projection system is desired to overcome the problems as described above in connection with the prior art.

### SUMMARY OF THE INVENTION

The object of the present invention is to provide a liquid crystal projection system with improved image performance, which increases the utility efficiency of the primary color lights, prevents the color phase shift appearing on the projected image, and thus improves the image contrast.

Another object of the present invention is to provide a liquid crystal projection system with improved image performance, which is simple in manufacture, easy in assembly and low in cost.

To achieve the above objects of the present invention, a liquid crystal projection system in accordance with the present invention comprises a light source for emitting white light of three primary colors (red, green, blue; R, G, B), a polarizer for polarizing the white light so as to obtain a polarized light beam, a separating mirror, first and second reflecting mirrors, first and second polarization separators, a half-wave plate disposed on the output side of the first polarization separator, a color separator, an image modulation device and a projection lens for projecting the output light beam onto a screen. The separating mirror splits the incident polarized light beam into two sets of light beams, a polarized monochromatic light beam containing a single primary color and a polarized bichromatic light beam containing the other two primary colors. The polarized monochromatic light beam is sequentially reflected by the first reflecting mirror, converged by a first converging lens, incident into the first polarization separator for polarization splitting, and output to the image modulation device for modulation and polarization transformation. The modulated and converted monochromatic light beam is further transformed to a light beam with reversed polarization by the half-wave plate, and thus the monochromatic light beam is finally incident into the second polarization separator in its original polarization state. The polarized bichromatic light beam is sequentially reflected by the second reflecting mirror, converged by a second converging lens, incident into the second polarization separator for polarization splitting, and transmitted to the color separator for separating the two primary colors. The image modulation device is arranged on sides of the first polarization separator and the color separator for respectively receiving and modulating the monochromatic and bichromatic light beams. The polarizations of the monochromatic and bichromatic light beams are transformed by the image modulation device before output. The projection lens is disposed on one side of the second polarization separator for receiving the modulated and transformed light beams and projecting the combined light beam to the screen for display.

In comparison with the prior art, in the liquid crystal projection system of the present invention, the monochromatic light beam from the separating mirror is incident into the first and second polarization separators in an S-polarization state, and the bichromatic light beam from the separating mirror is incident into the second polarization separator and the color separator also in an S-polarization state. This significantly increases the utility efficiency of the primary color lights from the light source, effectively decreases the likelihood that color phase shift occurs and improves the image contrast, whereby the projection image performance of the present system is increased. Further, the liquid crystal projection system of the present invention achieves the light polarization and separation functions by employing two polarization separators and one color separator that are cemented together as an L-shaped prism module. Within the L-shaped prism module, no additional optical elements are arranged therebetween except for a half-wave plate, which decreases the system cost and increases the system reliability. This L-shaped prism module may be composed of six, five or even four conventional isosceles right-angle prisms. Therefore, liquid crystal projection system of the present invention also has the advantages of simple manufacture, easy assembly and low cost.

### BRIEF DESCRIPTION OF THE DRAWINGS

The present invention may best be understood through the following description with reference to the accompanying drawings, in which:

FIG. 1 is a schematic view illustrating the configuration of a conventional liquid crystal projection system;

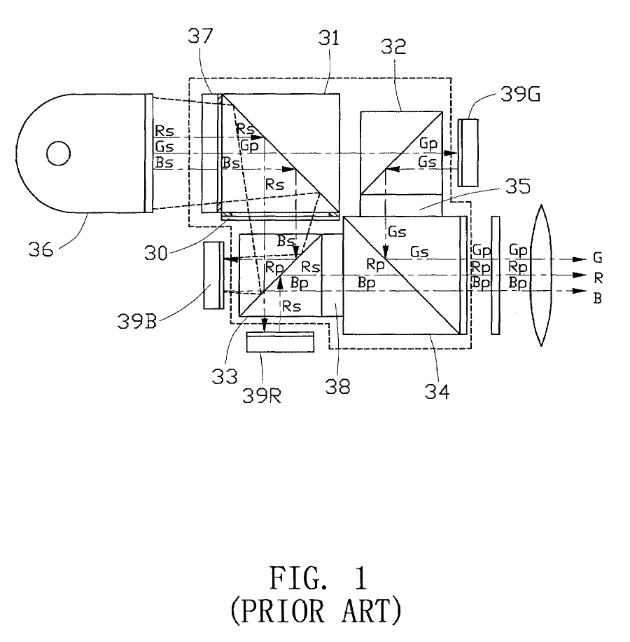

FIG. 2 is a schematic view illustrating the configuration of a liquid crystal projection system in accordance with a first embodiment of the present invention;

FIG. 3 is a schematic view illustrating the configuration of a liquid crystal projection system in accordance with a second embodiment of the present invention; and

FIG. 4 is a schematic view illustrating the configuration of a liquid crystal projection system in accordance with a third embodiment of the present invention.

### DETAILED DESCRIPTION OF THE PREFERRED EMBODIMENTS

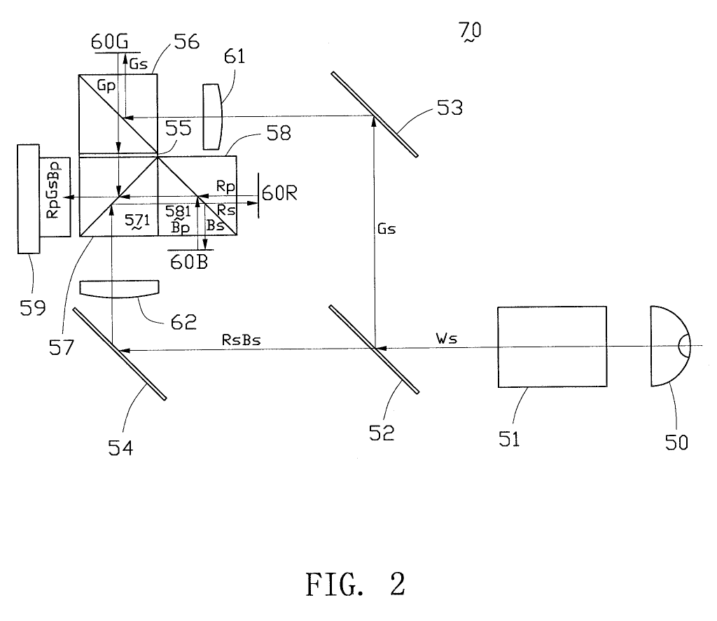

Referring to FIG. 2, a liquid crystal projection system constructed in accordance with a first embodiment of the present invention, generally designated with reference numeral 70, comprises a light source 50 for emitting white light, a polarizer 51 for polarizing the white light so as to obtain a polarized light beam, a separating mirror 52 for providing separated light beams, first and second reflecting mirrors 53, 54 for light reflection, a half-wave plate 55 (λ/2 wave plate, λ=632.8 nm) for transforming the polarization of an incident light beam, first and second polarization separators 56, 57 for polarization splitting, a color separator 58, an image modulation device 60 for light modulation and transformation, and a projection lens 59 for projecting the output light beam onto a screen. The polarizer 51 is disposed on an output light path of the light source 50 for polarizing the non-polarized incident white light into a polarized white light beam Ws (S denotes a perpendicular polarization) of three primary colors (red, green, blue; R, G, B). The polarizer 51 and the light source 50 together constitute a polarized light source. Further, the liquid crystal projection system 70 also comprises first and second converging lenses 61, 62 for converging the incident light.

The separating mirror 52 and the second reflecting mirror 54 are positioned along a light output path of the polarizer 51. The separating mirror 52 is adapted to separate the polarized white light beam Ws of three primary colors R, G, B from the polarizer 51 into two sets of light beams, a polarized monochromatic light beam containing a single primary color and a polarized bichromatic light beam containing the other two primary colors. Preferably, the polarized monochromatic light beam contains the green color G, and the polarized bichromatic light beam contains the red and blue colors R, B. The monochromatic light beam Gs is reflected by the first reflecting mirror 53 positioned above the separating mirror 52, and the bichromatic light beam (Rs, Bs) is reflected by the second reflecting mirror 54 positioned on the left side of the separating mirror 52.

The first polarization separator 56, the second polarization separator 57 and the color separator 58 are combined together as an L-shaped prism module by cementing. The first polarization separator 56 is adapted to transmit or reflect the incident monochromatic light beam according to the polarization state (P-polarization or S-polarization) thereof. The second polarization separator 57, which is positioned right below the first polarization separator 56 and proximate to the projection lens 59, is adapted to transmit and/or reflect the incident bichromatic light beam according to the polarization states (P-polarization or S-polarization) of the two constitute primary colors thereof. The color separator 58 is positioned on the right side of the second polarization separator 57, and is adapted to reflect one constitute primary color light of the incident bichromatic light beam and transmit the other constitute primary color light. Each of the first and second polarization separators 56, 57 is in the form of a PBS that is formed by cementing the bottom sides of two conventional isosceles right-angle prisms. The color separator 58 is in the form of a dichroic prism that is also formed by cementing the bottom sides of two conventional isosceles right-angle prisms.

The image modulation device 60 is adapted to modulate the incident polarized light into a polarized light having a reversed polarization and carrying an image signal. The image modulation device 60 is composed of a first reflective liquid crystal panel 60G, a second reflective liquid crystal panel 60B and a third reflective liquid crystal panel 60R. The first reflective liquid crystal panel 60G is arranged on one side of the first polarization separator 56, and the second and third reflective liquid crystal panels 60B, 60R are arranged on two respective sides of the color separator 58. The projection lens 59 is disposed on one side of the second polarization separator 57 for projecting the modulated and transformed light beam from the image modulation device 60 onto the screen for display.

The half-wave plate 55 is disposed between the first and second polarization separators 56, 57 for transforming the polarization of the incident light beam. The first converging lens 61 is arranged between the first reflecting mirror 53 and the first polarization separator 56, and the second converging lens 62 is arranged between the second reflecting mirror 54 and the second polarization separator 57. The employment of the two converging lenses 61, 62 is to converge the incident light beam and thus improve the light utility efficiency.

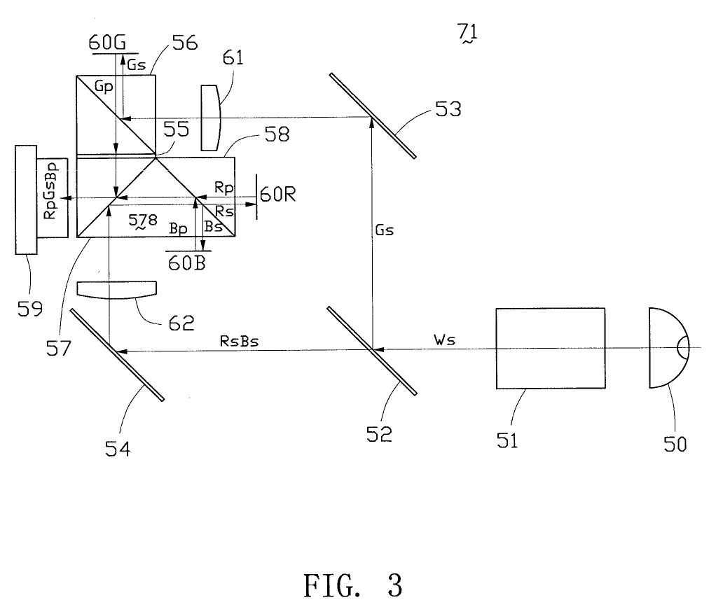

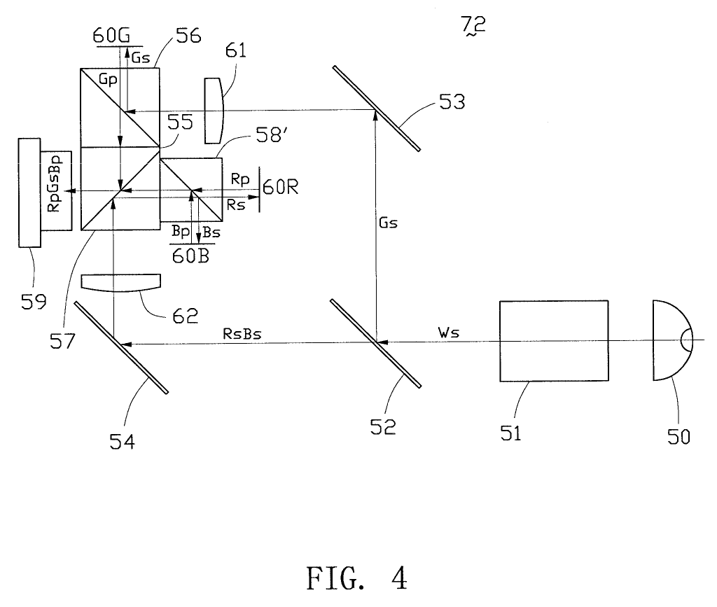

FIGS. 3 and 4 respectively illustrate a liquid crystal projection system in accordance with the second and third embodiments of the present invention.

FIG. 3 shows a liquid crystal projection system 71 in accordance with the second embodiment of the present invention. In this embodiment, the polarizer 51 outputs an S-polarized white light beam Ws of three primary colors R, Q B to the separating mirror 52. The separating mirror 52 separates the white light beam Ws into two sets of polarized light beams, a monochromatic light beam Gs and a bichromatic light beam (Rs, Bs). The separating mirror 52 reflects the monochromatic light beam Gs to the first reflecting mirror 53 positioned thereabove, and transmits the bichromatic light beam (Rs, Bs) to the second reflecting mirror 54 positioned on the left side thereof. The monochromatic light beam or green light beam Gs is reflected by the first reflecting mirror 53 to the first converging lens 61 for convergence onto the first polarization separator 56. The first polarization separator 56, in the form of a PBS, is adapted to transmit P-polarized light and reflects S-polarized light. Therefore, the green light beam Gs from the first converging lens 61 is reflected by the first polarization separator 56 to the first reflective liquid crystal panel 60G The first reflective liquid crystal panel 60G transforms the incident green light beam Gs into a P-polarized green light beam Gp, and modulates it into a green light beam Gp carrying green image signal. After transformation and modulation, the green light beam Gp is reflected by the first reflective liquid crystal panel 60G back to the first polarization separator 56, and is further transmitted by the first polarization separator 56 to the half-wave plate 55. The half-wave plate 55 transforms the P-polarized green light beam Gp into an S-polarized green light beam Gs before it is incident into the second polarization separator 57.

The bichromatic light beam (Rs, Bs) output by the separating mirror 52 is sequentially reflected by the second reflecting mirror 54, converged by the second converging lens 62 and incident into the second polarization separator 57. The second polarization separator 57 is also in the form of a PBS for transmitting P-polarized light and reflecting S-polarized light. Therefore, the bichromatic light beam (Rs, Bs) is reflected by the second polarization separator 57 into the color separator 58. The color separator 58, in the form of a bichromatic prism, is adapted to reflect blue light and transmit red light. Accordingly, the blue light Bs in the bichromatic light beam (Rs, Bs) is reflected by the color separator 58 to the second reflective liquid crystal panel 60B, while the red light Rs in the bichromatic light beam (Rs, Bs) is transmitted through the color separator 58 into the third reflective liquid crystal panel 60R. Consequently, the blue light Bs is transformed and modulated into a blue light beam Bp carrying blue image signal by the second reflective liquid crystal panel 60B, and the red light Rs is transformed and modulated into a red light beam Rp carrying red image signal by the third reflective liquid crystal panel 60R. The blue light beam Bp and red light beam Rp are then reflected back to the color separator 58 by the respective second and third reflective liquid crystal panels 60B, 60R. The color separator 58 respectively reflects and transmits the blue light beam Bp and red light beam Rp back into the second polarization separator 57. Further, the second polarization separator 57 transmits the incident blue and red light beams Bp, Rp from the color separator 58 to the projection lens 59, and reflects the incident green light beam Gs from the half-wave plate 55 to the projection lens 59. Finally, the projection lens 59 combines and projects the three primary color lights Bp, Rp, Gs carrying corresponding image signals onto the screen for image display.

In the second embodiment, the L-shaped prism module, consisting of the first polarization separator 56, the second polarization separator 57 and the color separator 58, is composed of five cemented isosceles right-angle prisms, not six isosceles right-angle prisms of the same size as in the first embodiment of FIG. 2. Referring to FIG. 3 in combination with FIG. 2, in the second embodiment of FIG. 3, in order to reduce the prism manufacture and assembly costs, a larger-sized isosceles right-angle prism 578 replaces the two small-sized isosceles right-angle prisms 571, 581 in FIG. 2. The size of the larger-sized isosceles right-angle prism 578 is proximately equal to the combined size of the two small-sized isosceles right-angle prisms 571, 581.

Referring to FIG. 4 in combination with FIG. 2, in the third embodiment, a small-sized color separator 58′, in the form of a dichroic prism, replaces the large-sized color separator 58 in the first embodiment of FIG. 2. This makes the configuration of the liquid crystal projection system more compact.

As described above, in the liquid crystal projection system of the present invention, the bichromatic light beam (preferably containing the red and blue lights R, B) is incident into the second polarization separator 57 and the color separator 58, 58′ in an S-polarization state, and the monochromatic light beam (preferably containing the green light G) is incident into the first and second polarization separators 56, 57 also in an S-polarization state. This is because that the utility efficiency of the S polarization light in a PBS is 99 percent, while the P polarization light is only 90 percent. The remaining unutilized 10 percent will cause the color phase shift problem due to light interference. Accordingly, making the three primary color lights of the incident white light enter the PBSs in an S-polarization state may increase the utility efficiency of the incident white light, effectively decrease the likelihood that color phase shift occurs and thus improve the image contrast, whereby the projection image performance is increased. Further, the liquid crystal projection system achieves the light polarization and separation functions by employing two polarization separators 56, 57 and one color separator 58, 58′ that are cemented together as an L-shaped prism module. Within the L-shaped prism module, no additional optical elements are arranged therebetween except for a half-wave plate 55, which decreases the system cost and increases the system reliability. This L-shaped prism module may be composed of six conventional isosceles right-angle prisms of the same size, or four conventional isosceles right-angle prisms of the same size plus one larger-sized conventional isosceles right-angle prism, or four conventional isosceles right-angle prisms of the same size plus two smaller-sized conventional isosceles right-angle prisms. Therefore, the liquid crystal projection system of the present invention also has the advantages of simple manufacture, easy assembly and low cost.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A liquid crystal projection system, comprising:
a light source providing an illumination beam of first polarization type;
a first separating element separating the illumination beam of first polarization type from the light source into a first illumination beam of first polarization type with a first wavelength range and a second illumination beam of first polarization type with a second wavelength range;
a second separating element receiving the second illumination beam of first polarization type and then separating it into a third illumination beam of first polarization type with a third wavelength range and a fourth illumination beam of first polarization type with a fourth wavelength range;
a first reflective type light modulator receiving the first illumination beam of first polarization type and generating a first imaging beam of second polarization type;
a second reflective type light modulator receiving the third illumination beam of first polarization type and generating a second imaging beam of second polarization type;
a third reflective type light modulator receiving the fourth illumination beam of first polarization type and generating a third imaging beam of second polarization type;
a half-wave plate receiving the first imaging beam of second polarization type and transforming it into a first imaging beam of first polarization type;
a first guiding element guiding the first illumination beam of first polarization type onto the first reflective light modulator and then guiding the first imaging beam of second polarization type onto the half-wave plate;
a second guiding element guiding the second illumination beam of first polarization type with the second wavelength range onto the second separating element and then receiving the first imaging beam of first polarization type, the second imaging beam of second polarization type and the third imaging beam of second polarization type so as to form a colorful image; and
a projection lens receiving and enlarging the colorful image.

2. The liquid crystal projection system as claimed in claim 1, further comprising a first reflecting element disposed on one output side of the first separating element for receiving and reflecting the first illumination beam of first polarization from the first separating element, and a second reflecting element disposed on the other output side of the first separating element for receiving and reflecting the second illumination beam of first polarization from the first separating element.

3. The liquid crystal projection system as claimed in claim 2, further comprising a first condensing element and a second condensing element, the first condensing element being disposed between the first reflecting element and the first guiding element, the second condensing element being disposed between the second reflecting element and the second guiding element.

4. The liquid crystal projection system as claimed in claim 1, wherein the illumination beam provided by the light source is an illumination beam of S-polarization.

5. The liquid crystal projection system as claimed in claim 1, wherein the first guiding element, the second guiding element and the second separating element are combined together as a unit.

6. The liquid crystal projection system as claimed in claim 5, wherein the first guiding element, the second guiding element and the second separating element are combined together as an L-shaped unit.

7. The liquid crystal projection system as claimed in claim 1, wherein the half-wave plate is disposed between the first and second guiding elements.

8. The liquid crystal projection system as claimed in claim 1, wherein the first separating element is a separating mirror.

9. The liquid crystal projection system as claimed in claim 1, wherein the first guiding element is a polarization beam splitter.

10. The liquid crystal projection system as claimed in claim 9, wherein the second guiding element is a polarization beam splitter.

11. The liquid crystal projection system as claimed in claim 10, wherein the second separating element is a dichroic prism.

12. The liquid crystal projection system as claimed in claim 11, wherein the size of the second separating element is smaller than that of the respective first and second guiding elements.

13. The liquid crystal projection system as claimed in claim 11, wherein the first guiding element, the second guiding element and the second separating element are combined together as an L-shaped unit, the L-shaped unit being composed of six isosceles right-angle prisms cemented with each other.

14. The liquid crystal projection system as claimed in claim 11, wherein the first guiding element, the second guiding element and the second separating element are combined together as an L-shaped unit, the L-shaped unit being composed of five isosceles right-angle prisms cemented with each other.

15. The liquid crystal projection system as claimed in claim 1, wherein the first reflective type light modulator is arranged on one side of the first guiding element, and the second and third reflective type light modulators are arranged on two respective sides of the second separating element.

16. A liquid crystal projection system, comprising:
a light source providing an illumination beam of first polarization type;
a first separating element separating the illumination beam of first polarization type from the light source into a first illumination beam of first polarization type with a first wavelength range and a second illumination beam of first polarization type with a second wavelength range;
a second separating element receiving the second illumination beam of first polarization type and then separating it into a third illumination beam of first polarization type with a third wavelength range and a fourth illumination beam of first polarization type with a fourth wavelength range;
an image modulation device receiving the first, third and fourth illumination beams of first polarization type and transforming and modulating them into first, second and third imaging beams of second polarization type, respectively;
a half-wave plate receiving the first imaging beam of second polarization type and transforming it into a first imaging beam of first polarization type;
a first guiding element guiding the first illumination beam of first polarization type onto the first reflective light modulator and then guiding the first imaging beam of second polarization type onto the half-wave plate;
a second guiding element guiding the second illumination beam of first polarization type with the second wavelength range onto the second separating element and then receiving the first imaging beam of first polarization type, the second imaging beam of second polarization type and the third imaging beam of second polarization type so as to form a colorful image; and
a projection lens receiving and enlarging the colorful image;
wherein the first guiding element, the second guiding element and the second separating element are combined together as an L-shaped unit.

17. The liquid crystal projection system as claimed in claim 16, wherein the illumination beam provided by the light source is an illumination beam of S-polarization.

18. The liquid crystal projection system as claimed in claim 16 further comprising a first reflecting element disposed on one output side of the first separating element for receiving and reflecting the first illumination beam of first polarization from the first separating element, and a second reflecting element disposed on the other output side of the first separating element for receiving and reflecting the second illumination beam of first polarization from the first separating element.

19. The liquid crystal projection system as claimed in claim 18 further comprising a first condensing element and a second condensing element, the first condensing element being disposed between the first reflecting element and the first guiding element, the second condensing element being disposed between the second reflecting element and the second guiding element.

20. The liquid crystal projection system as claimed in claim 16, wherein each of the first and second guiding elements is in the form of a polarization beam splitter, and the second separating element is in the form of a dichroic prism.

21. The liquid crystal projection system as claimed in claim 16, wherein the image modulation device consists of first, second and third reflective liquid crystal panels, the first reflective liquid crystal panel being arranged on one side of the first guiding element, the second and third reflective liquid crystal panels being arranged on two respective sides of the second separating element.
